(19) United States
(12) Patent Application Publication
(10) Pub. No.: US 2009/0044712 A1
(43) Pub. Date: Feb. 19, 2009

(54) Printing press with on-edge web tension control

(75) Inventor: Brian James Milliken, Newmarket, NH (US)

Correspondence Address: Davidson, Davidson & Kappel, LLC, 485 7th Avenue, 14th Floor, New York, NY, 10018, US

(73) Assignee: Goss International Americas, Inc., Dover, NH (US)

(21) Appl. No.: 11/893,674

(22) Filed: Aug. 16, 2007

(51) Int. Cl. B41F 13/54

(52) U.S. Cl. 101/228; 101/483; 101/484

(57) ABSTRACT

A web printing press is provided including printing units and a vacuum cantilever lead roll having a vertical rotational axis. Methods are also provided.

The present invention relates generally to printing presses.

### BACKGROUND

U.S. Pat. No. 6,161,604 discloses a web-fed rotary printing press where a web of material is fed from a roll stand, through an infeed, then through one or more printing units, a dryer and a chill roll stand. The web may be fed to a slitter mechanism and then into a cutting/folding cylinder section of a folder. During the web-up process, the web is initially fed through the press and is fed sequentially from the roll stand through to the folder. The process generally involves two people manually feeding the web through each component of the press system. If the web is cut into multiple ribbons by the slitter, additional personnel are needed to process the multiple ribbons. The web-up process adversely affects productivity by causing significant down-time for the printing press.

During the web-up process, the web tension is low. U.S. Pat. No. 6,499,639 discloses that paper differences, environmental conditions and press evolutions such as web splicing may cause web tension variation. Tension in the web must be maintained within a desired range in order to achieve smooth operation of the printing press.

Both U.S. Pat. Nos. 6,161,604 and 6,499,639 are hereby incorporated by reference herein.

### SUMMARY OF THE INVENTION

The present invention provides a web printing press comprising printing units and a vacuum cantilever lead roll having a vertical rotational axis.

The present invention also provides a method for webbing up a web on-edge comprising applying vacuum pressure to a web using the vacuum cantilever lead roll and pulling the web by hand past the vacuum cantilever lead roll.

The present further provides a method for holding a web on-edge during printing comprising applying vacuum pressure to the web using the vacuum cantilever lead roll, measuring a web tension, and controlling the vacuum pressure as a function of the web tension.

### BRIEF DESCRIPTION OF THE DRAWINGS

Further features and advantages of the present invention will become apparent from the following detailed description taken in conjunction with the accompanying drawings, in which:

FIG. 1 shows a printing press according to the present invention;

FIG. 2 shows a web control system section of the press of FIG. 1;

FIG. 3 shows a vacuum cantilever lead roll of FIG. 2;

FIG. 4 shows the internal components of the vacuum cantilever lead roll of FIG. 3; and

FIG. 5 shows the top view of the vacuum cantilever lead roll of FIG. 3.

### DETAILED DESCRIPTION OF A PREFERRED EMBODIMENT

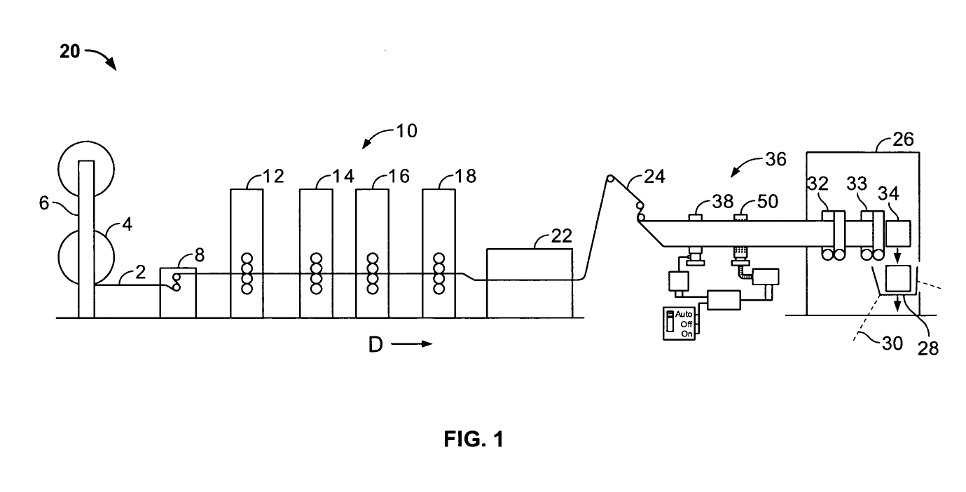

FIG. 1 shows a web rotary printing press 20 which includes a roll stand 6, an infeed mechanism 8, a horizontal web 2, a first printing unit 12, a second printing unit 14, a third printing unit 16, a fourth printing unit 18, a dryer 22, a folder superstructure 24, and a web control system 36. Each of printing units 12, 14, 16, 18 can, for example, print a different color, such as magenta, cyan, yellow and black.

Folder superstructure 24 can turn web 2 vertically on-edge before it passes web control system 36. The on-edge web 2 can enter a “horizontal” folder 26 with two pairs of perforated cutters 32, 33 that form signatures 34. A horizontal folder as defined herein is one where the cutters have a vertical axis. Signatures 34 may be collected by a conveyor 30. Conveyor 30 may have a plurality of pockets 28 (one being shown in cross-section) receiving the on-edge signatures 34. U.S. Pat. No. 6,082,724 showing a pocket conveyor is incorporated by reference herein.

During web-up, at a first phase of printing press operation, web 2 is pulled from roll stand 6, for example by technicians, and can be manually fed sequentially through press 20. When web 2 is fed on-edge, two technicians can control web slack and feed web 2 through to horizontal folder 26. Web-up time is reduced by allowing web control system 36 to control web slack since web 2 will be held up in its on-edge position by vacuum lead roll 50.

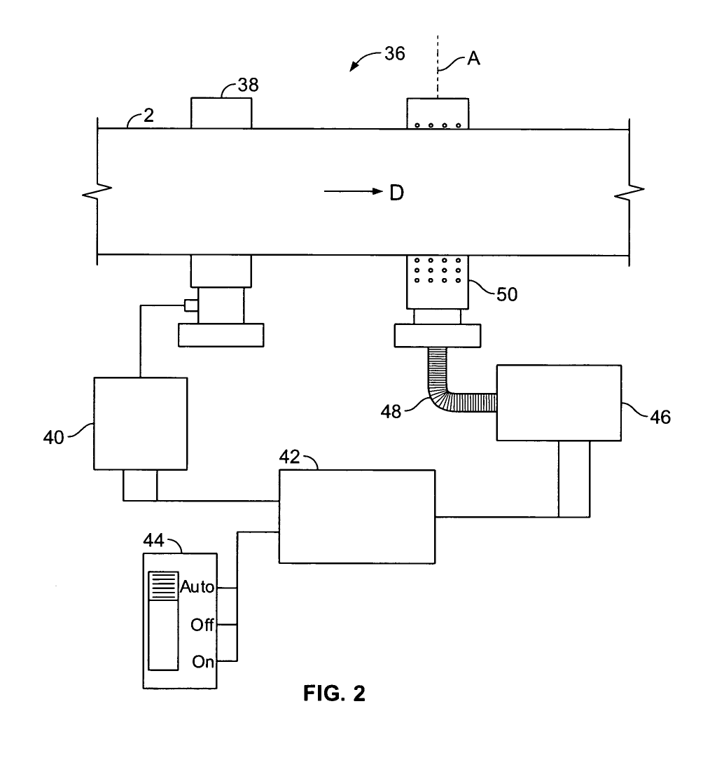

FIGS. 1 and 2 illustrate that, during a second phase when the printing press is operating, web control system 36, a tension transducer roll 38 and vacuum lead roll 50 are controlling the web tension. Transducer roll 38 senses current web tension and compares the tension against a minimum fall-off tension value. The tension exerted by vacuum lead roll 50 is to equal or to exceed this minimum fall-off tension value but is to remain below a tension value that would induce web tearing.

FIG. 2 illustrates that vacuum lead roll 50 has an axis A perpendicular to the direction of travel D of on-edge web 2. Vacuum lead roll 50 uses the power of vacuum pump 46 to hold the web 2 against vacuum roll 50 during a first phase of printing press operation, i.e. web-up, when web tension is usually low. Vacuum roll 50 is attached to vacuum pump 46 by using a vacuum pump attachment 48, such as a flexible tube.

In the illustrated embodiment of FIG. 2, a 3-location switch 44 has three possible values which is part of a control loop. The control loop includes tension transducer roll 38, a transducer circuit 40, a motor control 42 and 3-location switch 44 whose output will affect how vacuum lead roll 50 and vacuum pump 46 function to control web tension. In this embodiment, when switch 44 is OFF, vacuum pump 46 is always off. When switch 44 is ON, vacuum pump 46 is always on, for example, as during web-up. When switch 44 is in the AUTO position, vacuum pump 46 is on or off depending on the tension value sensed by transducer roll 38 as compared to an experimentally determined minimum fall-off tension. Thus, instead of inefficiently having vacuum roll 50 and vacuum pump 46 on continuously, vacuum pump 46 can operate intermittently.

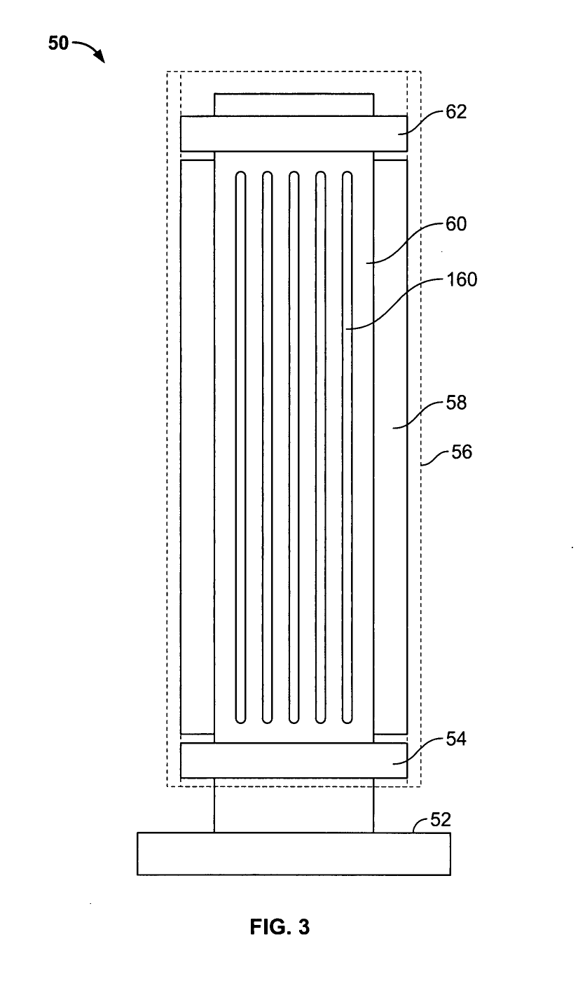

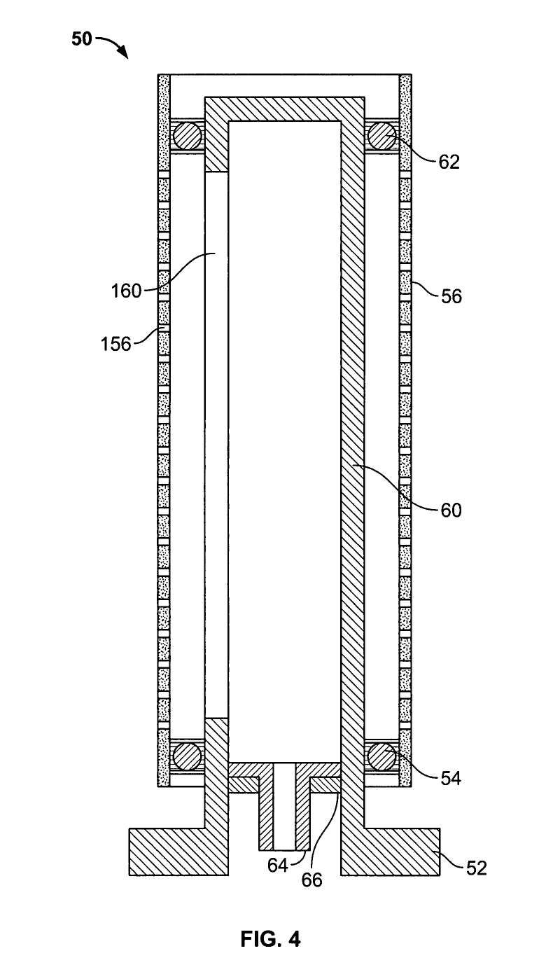

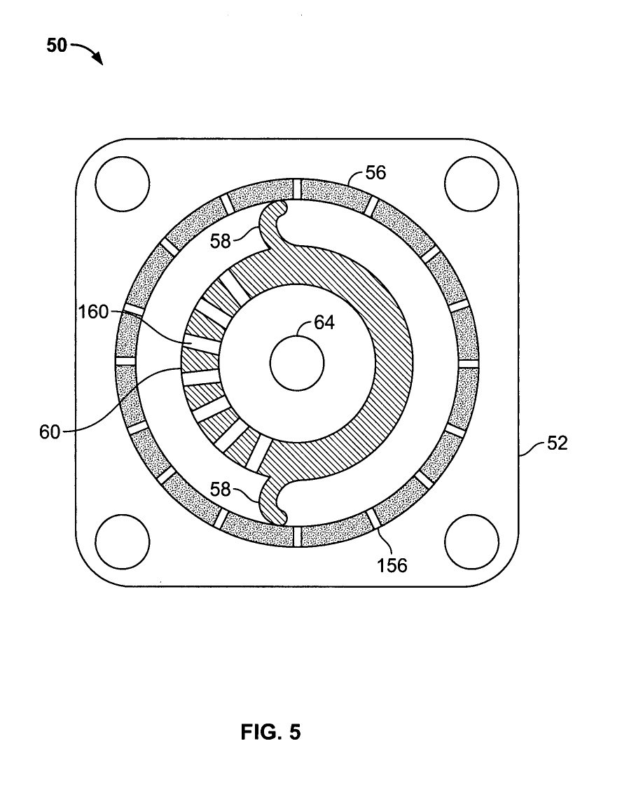

FIGS. 3, 4 and 5 detail the internal operation and function of vacuum lead roll 50. Openings 160 in a fixed inner shell 60 pull the air through holes 156 (FIG. 4) in a rotating outer shell 56 and into vacuum pump 46 (FIG. 2). Shields 58 (FIGS. 3 and 5) block the movement of the air and direct the air to holes 160 on the backside of fixed inner shell 60 according to the present invention. Shields 58 may be made of a flexible low-friction material or have a low-friction coating such as PTFE to permit rotation of outer shell 56 with respect to shields 58. Friction between moving on-edge web 2 (FIG. 2) and vacuum lead roll 50 enables the rotation of rotating outer shell 56 in the direction of travel D. Ball bearing assemblies 54, 62 provide rotating outer shell 56 the ability to turn with little frictional resistance. Thus, as web 2 is held against rotating outer shell 56, outer shell 56 can rotate.

FIG. 4 illustrates the attachment section of vacuum lead roll via a mounting flange 52. Holes 156, 160 pull air into a vacuum hose flange 64 through vacuum pump attachment 48 (FIG. 2) and into vacuum pump 46.

The foregoing merely illustrates the principles of the invention. It will thus be appreciated that those skilled in the art will be able to devise numerous other arrangements which embody the principles of the invention and are thus within its spirit and scope. For example, based on the above disclosure, it is apparent that the principles of the invention can readily accommodate different control schemes other than 3-location switch 44, such as a digital signal processor (DSP) or a microcontroller, to achieve the benefits of the invention. Another example is that tension could still be easily controlled when web 2 and web control system 36 are fixed at any other angle falling between 0 degrees and 90 degrees and still embody the principles of the invention.

What is claimed is:

1. A web printing press comprising:
printing units; and
a vacuum cantilever lead roll having a vertical rotational axis.

2. The web printing press as recited in claim 1 further comprising a vacuum pump attached to the vacuum cantilever lead roll.

3. The web printing press as recited in claim 1 wherein the vacuum cantilever lead roll has a fixed inner shell and a rotating outer shell.

4. The web printing press as recited in claim 3 wherein the vacuum cantilever lead roll further includes bearings between the fixed inner shell and the rotating outer shell.

5. The web printing press as recited in claim 3 wherein the vacuum cantilever lead roll further includes shields between the fixed inner shell and the rotating outer shell.

6. The web printing press as recited in claim 1 further comprising:
a transducer roll; and
a controller;
the controller receiving an input from the transducer roll; and
the controller controlling a vacuum pressure in the vacuum cantilever lead roll as a function of the input.

7. The web printing press as recited in claim 1 wherein the transducer roll is upstream of the vacuum cantilever lead roll.

8. A method for webbing up a web on-edge comprising:
applying vacuum pressure to a web using a vacuum cantilever lead roll; and
pulling the web by hand past the vacuum cantilever lead roll.

9. A method for holding a web on-edge during printing comprising:
applying vacuum pressure to a web using a vacuum cantilever lead roll;
measuring a web tension; and
controlling the vacuum pressure as a function of the web tension.
